(19) United States
(12) Patent Application Publication
(10) Pub. No.: US 2025/0052407 A1
(43) Pub. Date: Feb. 13, 2025

(54) LIGHTING APPARATUS

(71) Applicant: LEEDARSON LIGHTING CO.,LTD., Zhangzhou (CN)

(72) Inventors: Ling Yang, Zhangzhou (CN); Hongbin Lin, Zhangzhou (CN)

(21) Appl. No.: 18/799,449

(22) Filed: Aug. 9, 2024

(30) Foreign Application Priority Data
Aug. 11, 2023 (CN) 202322165770.9

(51) Int. Cl. F21V 21/28; F21V 23/00; F21V 23/04; F21V 23/06; F21Y 107/50; H05B 47/115; H05B 47/14; H05B 47/155

(52) U.S. Cl. CPC F21V 21/28; F21V 23/002; F21V 23/009; F21V 23/0471; F21V 23/06; H05B 47/115; H05B 47/14; H05B 47/155; F21Y 2107/50

(57) ABSTRACT

A lighting apparatus includes a driver module, multiple light source modules and a unified fastener. The driver module includes a driver circuit and a driver housing. The driver circuit converts an external power source to multiple driving currents. Each light source module has a light source and a light housing. The light housing encloses the light source and provides a light opening for a light of the light source to pass through. Each light source has a power wire. The power wires of the light sources have multiple wire ends coupled to the unified fastener to receive the driving currents of the driver circuit.

### FIELD

The present invention is related to a lighting apparatus, and more particularly related to a lighting apparatus with a flexible configuration.

### BACKGROUND

LED (Light Emitting Diode) technology has undergone significant development since its inception in the early 20th century. The first practical LED was developed in 1962 by Nick Holonyak Jr., a scientist at General Electric. Initially, LEDs were limited to emitting low-intensity red light and were used primarily as indicator lights in electronic devices. These early LEDs were inefficient and expensive, which restricted their applications. However, the fundamental principle of electroluminescence, where materials emit light in response to an electric current, laid the groundwork for future advancements.

Throughout the 1970s and 1980s, improvements in materials and manufacturing techniques led to the development of LEDs that could emit light in different colors, including green and yellow. These advancements were driven by the discovery and utilization of new semiconductor materials like gallium phosphide and gallium arsenide. Concurrently, researchers worked on enhancing the efficiency and brightness of LEDs, making them more suitable for practical applications. By the late 1980s, LEDs were being used in digital displays, traffic lights, and signage, though they were still not efficient enough for widespread lighting applications.

The breakthrough that revolutionized LED technology came in the 1990s with the development of blue LEDs by Shuji Nakamura and his colleagues. Using gallium nitride (GaN) and indium gallium nitride (InGaN) as the semiconductor materials, they were able to create high-brightness blue LEDs. This innovation was crucial because it enabled the creation of white light LEDs by combining blue LEDs with phosphors that convert blue light to white light. This breakthrough not only expanded the range of applications for LEDs but also paved the way for their use in general lighting.

As the 21st century progressed, LED technology continued to evolve rapidly. Advances in materials science, particularly the development of more efficient phosphors and quantum dot technologies, have significantly improved the color rendering and efficiency of LEDs. Additionally, improvements in manufacturing processes, such as the development of epitaxial growth techniques and surface coating technologies, have reduced production costs and increased the durability of LEDs. These enhancements have made LEDs the preferred choice for a wide range of applications, from residential and commercial lighting to automotive and outdoor lighting.

Today, LED technology is at the forefront of the lighting industry, driven by its energy efficiency, long lifespan, and versatility. LEDs consume significantly less energy compared to traditional incandescent and fluorescent bulbs, resulting in lower electricity bills and reduced environmental impact. Their long operational life, often exceeding 50,000 hours, reduces the need for frequent replacements, further contributing to their cost-effectiveness and sustainability. The versatility of LEDs allows for innovative lighting solutions, including smart lighting systems that can be controlled remotely and integrated into smart home ecosystems.

Looking ahead, the future of LED technology is promising, with ongoing research focusing on enhancing efficiency, reducing costs, and expanding applications. Emerging technologies such as organic LEDs (OLEDs) and micro-LEDs are poised to further transform the lighting and display industries. OLEDs, known for their flexibility and ability to produce high-quality, vibrant displays, are being used in advanced televisions and smartphones. Micro-LEDs, with their potential for higher brightness and energy efficiency, are expected to revolutionize display technology. As LED technology continues to evolve, it will play a crucial role in addressing global challenges related to energy consumption and sustainability.

Due to its numerous advantages, LED technology is rapidly replacing traditional light sources such as incandescent and fluorescent bulbs. One of the key features driving this replacement is energy efficiency. LEDs use significantly less electricity to produce the same amount of light as traditional bulbs, which translates to substantial energy savings. This efficiency is particularly important in large-scale applications, such as street lighting and commercial buildings, where the cumulative energy savings can be immense. Additionally, LEDs generate very little heat compared to incandescent bulbs, which convert much of their energy into heat rather than light. This not only makes LEDs safer and cooler to touch but also reduces the load on air conditioning systems, leading to further energy savings.

Another crucial feature of LED technology is its long lifespan. LEDs can last up to 25 times longer than traditional incandescent bulbs and about three to five times longer than compact fluorescent lamps (CFLs). This extended lifespan significantly reduces maintenance costs and the frequency of replacements. For businesses and municipalities, this means fewer disruptions and lower labor costs associated with changing bulbs. In residential settings, it translates to convenience and cost savings for homeowners. The long life of LEDs also contributes to environmental sustainability by reducing the number of bulbs that end up in landfills.

LEDs offer unparalleled versatility and design flexibility, which has expanded their use in a wide variety of lighting devices. Their small size and ability to be integrated into compact and innovative designs make them ideal for applications where traditional bulbs would be impractical. For example, LEDs are extensively used in automotive lighting, including headlights, tail lights, and interior lights, due to their durability, energy efficiency, and ability to produce bright, focused light. In the entertainment industry, LEDs are used in stage lighting, displays, and screens, offering vibrant colors and dynamic lighting effects that enhance performances and visual experiences.

In the realm of smart lighting, LEDs are a natural fit due to their compatibility with digital controls. Smart LED bulbs can be controlled remotely via smartphones or integrated into smart home systems, allowing users to adjust brightness, color, and timing according to their preferences. This capability not only adds convenience and customization but also contributes to energy efficiency through features like automatic dimming and motion detection. Moreover, the ability to control LED lighting remotely and programmatically makes them ideal for applications in smart cities, where streetlights and public lighting can be managed centrally to optimize energy use and maintenance schedules.

The environmental benefits of LED technology extend beyond energy efficiency and long lifespan. LEDs are free of hazardous materials such as mercury, which is present in fluorescent bulbs, making them safer for both users and the environment. Their reduced energy consumption means lower greenhouse gas emissions from power plants, contributing to efforts to combat climate change. Additionally, the development of recycling programs specifically for LEDs is making it easier to dispose of them responsibly, further minimizing their environmental impact.

Overall, the features of LED technology—energy efficiency, long lifespan, versatility, and environmental friendliness—have made them the preferred choice for a wide range of lighting applications. From residential homes to commercial buildings, public infrastructure to personal devices, LEDs are becoming ubiquitous. As technology continues to advance, the integration of LEDs into various lighting devices and systems will only increase, driving further innovations and benefits. This widespread adoption of LED technology marks a significant shift in the lighting industry, promising a more sustainable and efficient future.

LED panel lights have become increasingly popular in a variety of settings, including restaurants, living rooms, and commercial environments, due to their ability to provide soft, even lighting. These fixtures consist of an array of LEDs mounted on a flat panel that diffuses the light, creating a smooth and uniform glow that reduces glare and shadows. This quality of light is particularly desirable in spaces where comfort and ambiance are important, such as dining areas and living spaces. In commercial environments, the consistent and high-quality light from LED panels enhances visibility and productivity while maintaining a pleasing aesthetic.

One of the standout features of LED panel lights is their sleek, low-profile design, which allows them to be seamlessly integrated into ceilings and walls. This modern look is not only visually appealing but also saves space and makes the fixtures less obtrusive. The slim design of LED panel lights is ideal for environments with low ceilings or where a minimalist appearance is desired. Additionally, these lights often come in various shapes and sizes, offering flexibility in design and installation to suit different architectural styles and spatial requirements.

Despite the advantages of LED panel lights, there is a growing demand for even more flexible configurations to meet diverse lighting needs. People are increasingly looking for lighting solutions that can be customized and adjusted to fit their specific preferences and requirements. This has led to the development of panel lights with adjustable color temperatures and brightness levels. By incorporating tunable white technology, users can change the color temperature from warm to cool white, adapting the lighting to different activities and times of day. Dimmable options allow for control over light intensity, providing the right amount of light for any setting or mood.

In addition to adjustable lighting, smart technology is playing a significant role in enhancing the flexibility of LED panel lights. Smart panel lights can be controlled via remote controls, smartphone apps, or integrated into smart home systems. This allows users to create and save different lighting scenes, set schedules, and even automate lighting based on occupancy or natural light levels. In commercial environments, smart controls can optimize energy usage and enhance the lighting experience for employees and customers alike. For instance, in a restaurant, different lighting scenes can be programmed for lunch, dinner, and special events, creating the perfect ambiance for each occasion.

Modular designs are another innovation addressing the need for flexible configurations. Modular LED panel lights can be combined and arranged in various patterns to create custom lighting solutions. This adaptability is particularly useful in commercial environments where lighting needs may change over time or vary across different areas of a building. For example, in an office, modular panels can be reconfigured to accommodate changes in layout or function, ensuring that each workspace is optimally lit. Similarly, in retail settings, modular panels can highlight different product displays or create distinct zones within a store.

The continued evolution of LED panel light technology is driven by the desire to provide more personalized and adaptable lighting solutions. As manufacturers respond to consumer demand, we can expect to see further advancements in features such as color rendering, energy efficiency, and user-friendly controls. Innovations like dynamic daylight simulation, which mimics natural light patterns to support human circadian rhythms, and integration with other smart building systems will enhance the functionality and appeal of LED panel lights. By meeting the diverse needs of users in various settings, LED panel lights are set to remain a versatile and essential component of modern lighting design.

The prevalence of light-emitting devices in modern life cannot be overstated. From residential homes to commercial establishments, public infrastructure to personal gadgets, lighting solutions play a critical role in our daily activities and overall well-being. With the widespread adoption of light devices, even a small advancement in their technology or design can lead to significant improvements and widespread impact. These improvements not only enhance the functionality and user experience but also contribute to energy efficiency, cost savings, and environmental sustainability.

Given the extensive use of lighting devices, continuous innovation in this field is crucial. A key area of focus is the flexibility of lighting solutions. Users increasingly demand lighting systems that can be tailored to their specific needs and preferences. This includes the ability to adjust brightness and color temperature, customize lighting scenes, and integrate with smart home systems. Flexible lighting solutions can enhance comfort, productivity, and mood, making them highly desirable in various settings such as homes, offices, and public spaces.

In addition to flexibility, the functional capabilities of lighting devices are paramount. Modern lighting systems are expected to do more than just illuminate a space. They should support various activities, improve safety and security, and contribute to aesthetic appeal. For instance, in commercial environments, lighting can enhance the shopping experience or increase productivity in the workplace. In public spaces, intelligent lighting systems can provide dynamic illumination that responds to environmental conditions and user movement, improving safety and energy efficiency.

Cost is another critical factor in the development of lighting technologies. As lighting devices are ubiquitous, cost-effective solutions can lead to substantial savings for consumers and businesses alike. Advances that reduce the manufacturing and operational costs of lighting systems without compromising performance are highly beneficial. This includes innovations in materials, production processes, and energy consumption. Lower costs can accelerate the adoption of advanced lighting technologies, making them accessible to a broader range of users and applications.

Robustness and durability are essential considerations for lighting devices, especially in demanding environments. Lighting systems must withstand various conditions, including fluctuations in temperature, humidity, and mechanical stress. Enhancing the robustness of lighting devices ensures their longevity and reliability, reducing maintenance costs and minimizing disruptions. This is particularly important for applications in industrial settings, outdoor lighting, and critical infrastructure where consistent performance is crucial.

Ultimately, the pursuit of innovation in lighting technology involves a holistic approach that considers multiple factors: flexibility, functionality, cost, and robustness. By addressing these aspects, new advancements can bring about substantial improvements in human life. Enhanced lighting solutions can provide better quality of life through improved comfort and aesthetics, greater efficiency through reduced energy consumption and costs, and increased safety and productivity. As such, ongoing research and development in this field are not only beneficial but essential to harnessing the full potential of lighting technology to meet the evolving needs of society.

### SUMMARY

In some embodiments, a lighting apparatus includes a driver module, multiple light source modules and an unified fastener.

The driver module includes a driver circuit and a driver housing.

The driver circuit converts an external power source to multiple driving currents.

Each light source module has a light source and a light housing.

The light housing encloses the light source and provides a light opening for a light of the light source to pass through.

Each light source has a power wire. The power wires of the light sources have multiple wire ends coupled to the unified fastener to receive the driving currents of the driver circuit.

In some embodiments, the multiple driving currents are transmitted from the driver circuit via multiple power cables.

In some embodiments, the multiple power wires are respectively fixed to the power cables with multiple power connectors.

The power wires are fixed to the unified fastener.

In some embodiments, the unified fastener is a strain relief for absorbing and distributing tension placed on the power wires to prevent the power wires from being pulled out at their connection points.

In some embodiments, the light housing is protruding from a connection position of the driver housing to extend outwardly.

In some embodiments, the multiple light housings form a geometry extension shape.

In some embodiments, the light housing is a light wing that has the light opening facing to an illumination area.

In some embodiments, the light wings are foldable with respect to the driver housing to change their illumination areas.

In some embodiments, each light wing is detachable from the driver housing so that a number of the light wings are selectively coupled to the driver housing.

In some embodiments, a sensor is selectively attached to the light wing.

In some embodiments, the sensor includes a motion sensor for detection of a human motion for the driver circuit to determine whether to turn on the light source.

In some embodiments, the driver circuit detects installed light wings to determine and adjust control of the light sources in the light wings.

In some embodiments, the unified fastener is a plastic structure for fixing the wire ends of the power wires of the multiple light sources and for fixing a cable end of the power cable.

In some embodiments, the driver housing has a cover.

The unified fastener has a fixing connector for fixing the unified fastener to the cover after the wire ends are fixed to the unified fastener.

In some embodiments, in a first working mode, at least a portion of the light sources are disabled while turning on other portion of the light sources at a period of time.

In some embodiments, each light housing has an Edison cap to attach to a corresponding Edison socket of the driver housing.

In some embodiments, the driver circuit determines an independent driving current to each light source.

In some embodiments, the lighting apparatus may also include a manual switch disposed on a surface of the driver housing for control a setting of the driver circuit.

In some embodiments, the manual switch has multiple sub-switches each corresponding to one light source to change the setting of the corresponding light source.

In some embodiments, the multiple light sources have different optical parameters.

### BRIEF DESCRIPTION OF DRAWINGS

FIG. 1 illustrates a lighting apparatus embodiment.

FIG. 2 illustrates a wiring structure example.

FIG. 3 illustrates a fixing structure example.

FIG. 4 illustrates a zoom-up view of a wire connection.

FIG. 5 shows another lighting apparatus embodiment.

FIG. 6A and FIG. 6B show two operation modes of a lighting apparatus.

FIG. 7 shows a variation of the lighting apparatus embodiment.

### DETAILED DESCRIPTION

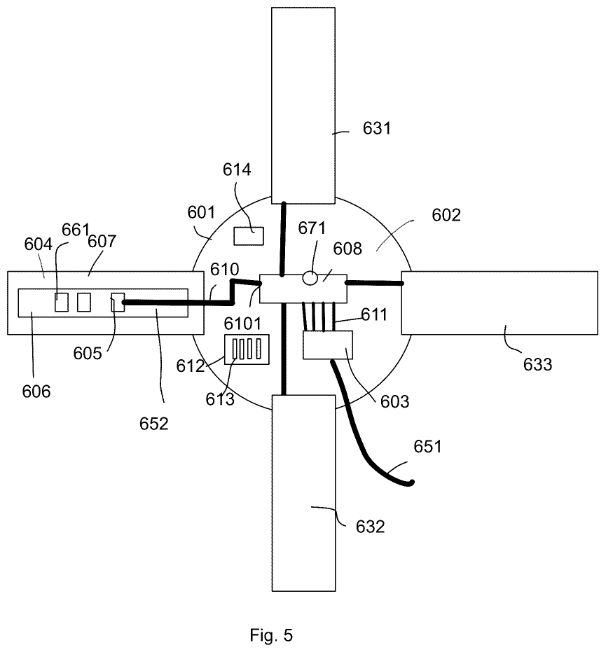

In FIG. 5, a lighting apparatus includes a driver module 601, multiple light source modules 604, 631, 632, 633 and an unified fastener 608.

The driver module 601 includes a driver circuit 603 and a driver housing 602.

The driver circuit 603 converts an external power source 631 to multiple driving currents 652. Each light module 604, 631, 632, 633 may have their different driving currents.

Each light source module 604 has a light source 605 and a light housing 607.

The light housing 607 encloses the light source 605 and provides a light opening 606 for a light of the light source 605 to pass through.

The light housing 607 may be made of plastic material leaving an opening for installing a lens or a diffusion transparent cover on the light opening 606.

Each light source has a power wire 610. The power wires 610 of the light sources 605 have multiple wire ends 6101 coupled to the unified fastener 608 to receive the driving currents 652 of the driver circuit 603.

Please note that one light module 604 is illustrated and explained above, the other light modules 631, 632, 633 are not repeated for brevity, because they share similar structures and are already illustrated on FIG. 5

In some embodiments, the multiple driving currents are transmitted from the driver circuit via multiple power cables 611. In this example, there are four power cables. In other embodiments, the multiple light sources may be connected in parallel, i.e. only one power cable is sufficient to provide power. In addition, there are two or three sub-wires in each wire, e.g. neutral line, fire line and ground line.

In some embodiments, the multiple power wires are respectively fixed to the power cables with multiple power connectors. For example, the power wire 610 from the light source 605 may be connected to a power cable 611 from the driver circuit with a connector. After that the connector or part of the power wire are fixed to the unified fastener 608. In other embodiments, the power wires and the power cables are fixed and coupled together with the unified fastener 608, e.g. using plug and lock structure for performing structural and electrical connection at the same time.

The power wires 611 are fixed to the unified fastener 608.

In some embodiments, the unified fastener is a strain relief for absorbing and distributing tension placed on the power wires to prevent the power wires from being pulled out at their connection points.

In some embodiments, the light housing is protruding from a connection position of the driver housing to extend outwardly. As illustrated in FIG. 5, there are four light housings 607 protruding from the connection position (the position between the light housing 607 and the driver housing 602).

In some embodiments, the multiple light housings form a geometry extension shape. In the example of FIG. 5, the four light housings form a cross geometric shape.

In some embodiments, the light housing is a light wing that has the light opening facing to an illumination area.

In some embodiments, the light wings are foldable with respect to the driver housing to change their illumination areas.

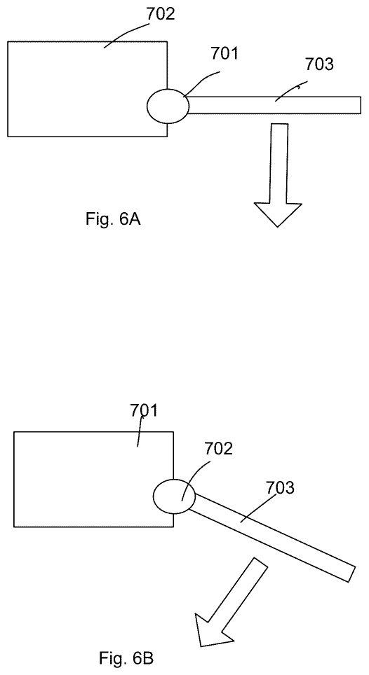

FIG. 6A and FIG. 6B show such an example. In FIG. 6A and FIG. 6B, a light housing 703 is coupled to the driver housing 702 with a rotation structure 701. The light housing 703 may be folded and rotated with respect to the driver housing 702 to change its light direction and consequently changes the illumination area it illuminates.

In some embodiments, each light wing is detachable from the driver housing so that a number of the light wings are selectively coupled to the driver housing.

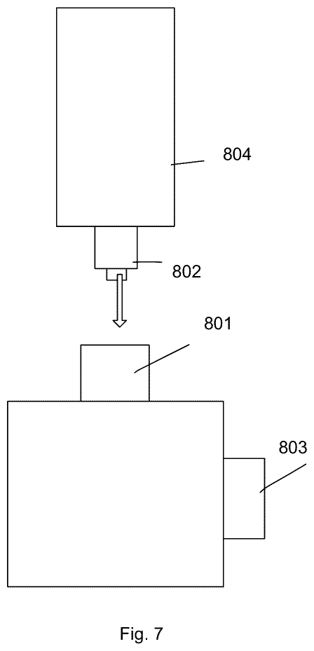

FIG. 7 shows such an example, the light wing 804 has an Edison cap 802 at its connection end to a corresponding Edison socket 801 in the driver housing. There may be other Edison socket 803 for selectively connecting to or not connecting to a light wing.

In FIG. 5, a sensor 661 is selectively attached to the light wing.

In some embodiments, the sensor 661 includes a motion sensor for detection of a human motion for the driver circuit to determine whether to turn on the light source.

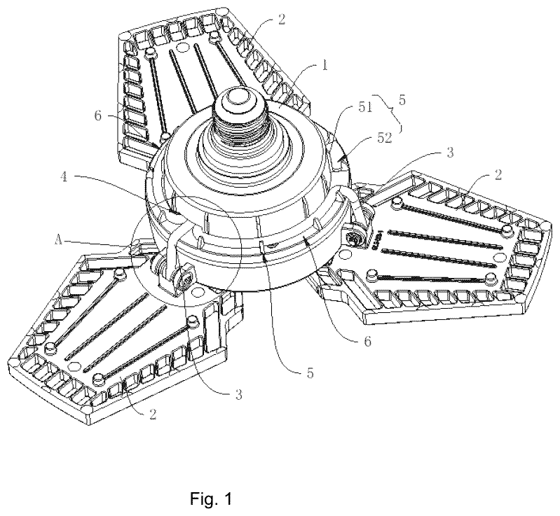

In some embodiments, the driver circuit detects installed light wings to determine and adjust control of the light sources in the light wings. FIG. 1 to FIG. 4 show such an example in a more details.

In some embodiments, the unified fastener is a plastic structure for fixing the wire ends of the power wires of the multiple light sources and for fixing a cable end of the power cable.

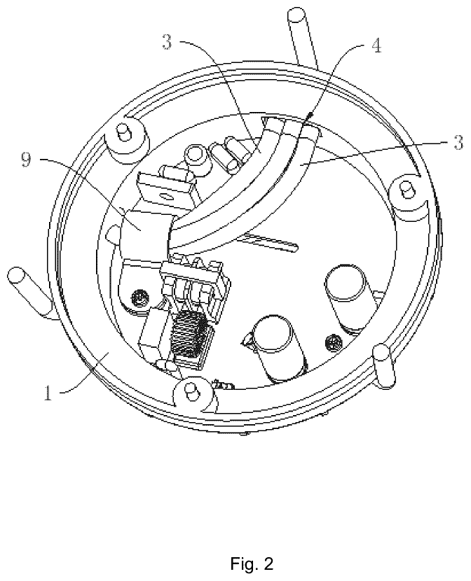

In some embodiments, the driver housing has a cover, which is illustrated in FIG. 2.

In FIG. 5, the unified fastener 608 has a fixing connector 671 for fixing the unified fastener to the cover of the light housing 602 after the wire ends are fixed to the unified fastener.

In some embodiments, in a first working mode, at least a portion of the light sources are disabled while turning on other portion of the light sources at a period of time.

In some embodiments, each light housing has an Edison cap to attach to a corresponding Edison socket of the driver housing, shown in FIG. 7.

In some embodiments, the driver circuit determines an independent driving current to each light source.

In FIG. 5, the lighting apparatus may also include a manual switch 612 disposed on a surface of the driver housing for control a setting of the driver circuit.

In some embodiments, the manual switch 612 has multiple sub-switches 613 each corresponding to one light source to change the setting of the corresponding light source.

In some embodiments, the multiple light sources have different optical parameters.

Therefore, the driver circuit 603 may control the light sources to generate mixed light with required color temperatures, colors or other optical parameters.

Please refer to FIG. 1 to FIG. 4. In this utility model embodiment, a garage light is provided, including a main lamp body 1 and multiple folding light panels 2 that are rotationally connected to the main lamp body 1. Each folding light panel 2 is electrically connected to the internal electrical components of the main lamp body 1 through flexible conductive elements 3. The main lamp body 1 is also provided with connecting holes 4 for the flexible conductive elements 3 to pass through, and the number of connecting holes 4 is less than the number of flexible conductive elements 3.

The main lamp body 1 refers to the main part of the entire lamp, which can include a main housing and a driving unit set inside the main housing. The main lamp body 1 can be equipped with or without lighting units.

The folding light panels 2 refer to the plate-like lighting components that are rotationally connected to the main lamp body 1. Generally, each folding light panel 2 is equipped with lighting units, which are electrically connected to the driving unit inside the main lamp body 1 through flexible conductive elements 3. The unfolding and folding of the folding light panels 2 can be achieved through the rotation of the folding light panels 2.

The flexible conductive elements 3 refer to conductive wires that have a certain length and flexibility. The flexible conductive elements 3 can be insulated wires, cables, etc.; they can also be flexible metal sheets or flat cables, etc.

The garage light provided in this embodiment has multiple folding light panels 2 on the main lamp body 1. The lighting units on the folding light panels 2 are connected to the driving unit inside the main lamp body 1 through flexible conductive elements 3. The connecting holes 4 on the main lamp body 1 allow the flexible conductive elements 3 to enter or extend out of the main lamp body 1 more conveniently. The number of connecting holes 4 and the number of anti-pull fixing elements 9 are both less than the number of flexible conductive elements 3. Compared with the prior art where each wire of the garage light needs to have a clearance structure, the connection between multiple folding light panels 2 and the main lamp body 1 can be completed by providing connecting holes 4 fewer than the flexible conductive elements 3 on the main lamp body 1. This simplifies the structure of the main lamp body 1 housing, thereby reducing the manufacturing and production costs of the lamp.

In one embodiment, as shown in FIG. 1 and FIG. 2, the number of connecting holes 4 is one, and multiple flexible conductive elements 3 all pass through the same connecting hole 4 to enter the main lamp body 1. Specifically, each folding light panel 2 corresponds to a flexible conductive element 3 connected to the driving unit inside the main lamp body 1. The number of connecting holes 4 is one, and multiple flexible conductive elements 3 extend out of the main lamp body 1 through connecting hole 4 and extend to the corresponding folding light panel 2. Having one connecting hole 4 makes the structure of the main lamp body 1 housing simpler, thereby simplifying the mold structure and processing for producing the housing, and reducing the manufacturing cost of the main lamp body 1.

In one embodiment, as shown in FIG. 2, the main lamp body 1 is equipped with an anti-pull fixing element 9 to compress and secure all the flexible conductive elements 3. The number of anti-pull fixing elements 9 is also one, and multiple flexible conductive elements 3 are compressed and fixed by the same anti-pull fixing element 9. Specifically, the main lamp body 1 is further provided with an anti-pull fixing element 9 to compress and secure the flexible conductive elements 3, which can prevent the flexible conductive elements 3 from being pulled during the rotation of the folding light panels 2, thereby avoiding the disconnection of the flexible conductive elements 3. The anti-pull fixing element 9 is positioned near the connecting hole 4, and multiple flexible conductive elements 3 are compressed and secured by a single anti-pull fixing element 9. Compared to the prior art where each flexible conductive element 3 uses an individual anti-pull fixing element 9 for fixation, this reduces the manufacturing cost of the lamp.

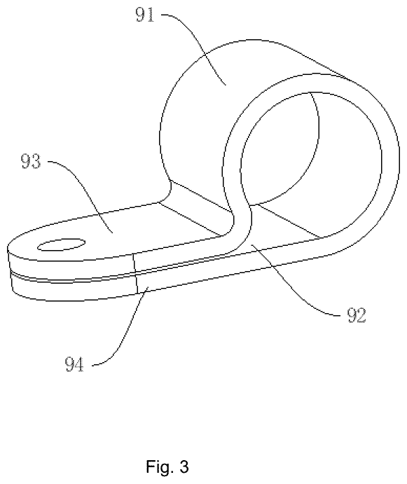

In one embodiment, as shown in FIG. 2 and FIG. 3, the anti-pull fixing element 9 includes an annular part 91, a first pressing member 93 connected to one end of the annular part 91, and a second pressing member 94 connected to the other end of the annular part 91. The second pressing member 94 and the first pressing member 93 are located on the same side of the annular part 91, and the distance between the second pressing member 94 and the first pressing member 93 is adjustable. When there is a gap between the second pressing member 94 and the first pressing member 93, a clearance opening 92 is formed between the two ends of the annular part 91. Specifically, the annular part 91 refers to a thin-walled component with a certain elasticity and curvature. The first pressing member 93 and the second pressing member 94 are plate-like or block-like components with a certain volume. To fix the flexible conductive elements 3, all the flexible conductive elements 3 are placed into the annular part 91 through the clearance opening 92, and then by reducing the distance between the first pressing member 93 and the second pressing member 94, the clearance opening 92 on the annular part 91 is closed. Simultaneously, the inner diameter of the annular part 91 gradually decreases as the distance between the first pressing member 93 and the second pressing member 94 is reduced, causing the inner wall of the annular part 91 to tightly adhere to the outside of the flexible conductive elements 3. The fixation of the flexible conductive elements 3 is achieved through the friction between the flexible conductive elements 3 and the inner wall of the annular part 91, making the fixation more convenient and more secure.

In one embodiment, as shown in FIG. 3, the anti-pull fixing element also includes a fastener. The first pressing member 93 and the second pressing member 94 are further provided with mounting through-holes for the fastener to pass through. The fastener sequentially passes through the mounting through-holes of the first pressing member 93 and the second pressing member 94, and is then connected to the main lamp body 1. Specifically, the fastener refers to a threaded component with a cap body at the end, and it is threadedly connected to the main housing's shell. The fastener sequentially passes through the mounting through-holes of the first pressing member 93 and the second pressing member 94, and is then connected to the main lamp body 1. The first pressing member 93 and the second pressing member 94 are both located in the area between the cap body and the main lamp body 1. By rotating the fastener, the cap body on the fastener gradually approaches the main lamp body 1, reducing the distance between the first pressing member 93 and the second pressing member 94 until multiple flexible conductive elements 3 are fixed. This process also connects the anti-pull fixing element 9 to the main housing.

In an optional embodiment, as shown in FIG. 3, the first pressing member 93 and the annular part 91 are integrally formed, and the second pressing member 94 and the annular part 91 are also integrally formed. This enhances the connection between the annular part 91 and the first pressing member 93 as well as the second pressing member 94, improving the overall strength of the anti-pull fixing element 9.

In another optional embodiment, as shown in FIG. 3, the annular part 91, the first pressing member 93, and the second pressing member 94 can all be made of metal material, with the entire anti-pull fixing element 9 formed by bending; alternatively, the annular part 91, the first pressing member 93, and the second pressing member 94 can all be made of plastic material and produced through injection molding.

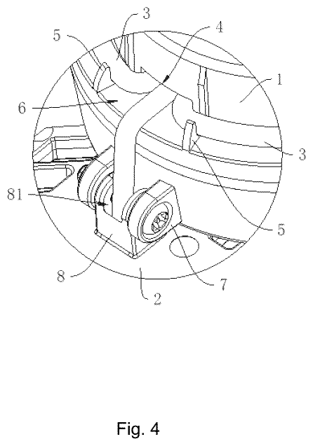

In one embodiment, as shown in FIG. 1 and FIG. 4, the main lamp body 1 is provided with a fixing structure, and the flexible conductive elements 3 are fixed to the exterior of the main lamp body 1 through the fixing structure. Specifically, the fixing structure refers to a structure set on the exterior of the main lamp body 1, whose function is to secure the flexible conductive elements 3 to the exterior of the main lamp body 1. The fixing structure can achieve the fixation of the flexible conductive elements 3 through a detachable connection method, such as clamping or adhering; it can also achieve the connection of the flexible conductive elements 3 to the main lamp body 1 through a fixed connection method, such as welding. When the flexible conductive elements 3 extend to the exterior of the main lamp body 1 through the connecting hole 4, they are fixed to the exterior of the main lamp body 1 through the fixing structure. Compared to the existing garage lights, where flexible conductive elements 3 are scattered on the exterior of the main lamp body 1, this design makes the overall appearance of the lamp more aesthetically pleasing while also reducing the risk of damage to the flexible conductive elements 3 when the folding light panels 2 rotate.

In one embodiment, as shown in FIG. 1 and FIG. 4, the fixing structure includes a clamping structure set on the outer wall of the main lamp body 1, with the parts of the flexible conductive elements 3 located outside the main lamp body 1 being detachably connected to the outer wall of the main lamp body 1 through the clamping structure. Specifically, the clamping structure refers to a structure that can clamp and secure the flexible conductive elements 3. The clamping structure can be an additional clamping component set on the exterior of the main lamp body 1, such as a clamping part, a pressing plate, or any other component with a clamping function; it can also be a groove structure directly recessed into the main lamp body 1, achieving the detachable connection of the flexible conductive elements 3 to the main lamp body 1 through the groove structure. The clamping connection method between the flexible conductive elements 3 and the main lamp body 1 makes the installation of the flexible conductive elements 3 more convenient.

In one embodiment, as shown in FIG. 1, the clamping structure includes multiple clamping components 5 set on the main lamp body 1, with adjacent clamping components 5 spaced apart from each other. Specifically, each clamping component 5 has a clamping structure for securing the flexible conductive elements 3. Multiple clamping components 5 are sequentially spaced along the extension path of the flexible conductive elements 3. This design allows the flexible conductive elements 3 to be fixed at intervals, ensuring the secure fixation of the flexible conductive elements 3 while reducing the overall manufacturing cost of the clamping structure, thereby lowering the production cost of the main lamp body 1.

In one embodiment, as shown in FIG. 1, each clamping component 5 includes a body part 51 set on the main lamp body 1, and a limiting slot 52 set on the body part 51. Specifically, the body part 51 refers to a component with a certain volume set on the exterior of the main lamp body 1, which can be block-shaped, plate-shaped, spherical, etc. The limiting slot 52 refers to a groove structure with a certain depth set on the clamping component 5, with both ends of the limiting slot 52 being open to facilitate the passage of the flexible conductive elements 3. When the flexible conductive elements 3 are placed into the limiting slot 52, they can extend out of the limiting slot 52 from the open structure at both ends. To fix the flexible conductive elements 3, they can be placed into the limiting slot 52, and the two sidewalls of the limiting slot 52 clamp the flexible conductive elements 3 to achieve fixation, making the fixation of the flexible conductive elements 3 more convenient.

In another optional embodiment, as shown in FIG. 4, the clamping components 5 and the main lamp body 1 are integrally injection-molded, making the connection between the clamping components 5 and the main lamp body 1 more secure and reliable, thereby enhancing the safety of the lamp.

In one embodiment, as shown in FIG. 2, the flexible conductive elements 3 are wires, and the width of the opening of the limiting slot 52 is smaller than the diameter of the flexible conductive elements 3. This can, to some extent, prevent the flexible conductive elements 3 from slipping out of the limiting slot 52, making the fixation of the flexible conductive elements 3 in the limiting slot 52 more secure and safe.

In one embodiment, as shown in FIG. 1 and FIG. 4, the main lamp body 1 is further provided with a stepped surface 6 around its periphery, and multiple clamping components 5 are set on the stepped surface 6. The stepped surface 6 refers to a plane set at an angle to the peripheral surface of the main lamp body 1. The arrangement of the stepped surface 6 makes it more convenient to set the clamping components 5. Moreover, the connecting hole 4 is located above the stepped surface 6, allowing the flexible conductive elements 3 to extend directly along the stepped surface 6 after emerging from the connecting hole 4, making the arrangement of the flexible conductive elements 3 more aesthetically pleasing.

Additionally, the stepped surface 6 is positioned on the back of the light-emitting surface of the main lamp body 1. Generally, when the lamp is installed at a higher position, the light-emitting surface is located at the bottom of the lamp. In this case, the stepped surface 6 is on the back of the light-emitting surface of the main lamp body 1, allowing the main lamp body 1 to shield the clamping components 5 and the flexible conductive elements 3 on them, making the lamp more visually appealing.

In one embodiment, as shown in FIG. 4, the main lamp body 1 is provided with a first hinge 7, and the folding light panels 2 are provided with second hinges 8 that are hinged to the first hinges 7. Specifically, the first hinge 7 refers to a component with a certain volume set on the main lamp body 1, which can be cylindrical, block-shaped, or plate-shaped. The second hinge 8 refers to a component with a certain volume set on the folding light panels 2, which can also be cylindrical, block-shaped, or plate-shaped. One end of the first hinge 7 and one end of the second hinge 8 are interleaved and penetrated by a rotating shaft, thereby achieving the hinge connection between them, making the folding and unfolding operation of the folding light panels 2 more convenient.

In a specific embodiment, as shown in FIG. 4, the first hinges 7 are plate-shaped components set on the main lamp body 1, with two first hinges 7 spaced apart from each other. The second hinge 8 is cylindrical and set on the folding light panel 2, with one end of the second hinge 8 positioned between the two first hinges 7, making the hinge connection between the first hinges 7 and the second hinge 8 more stable and secure.

In one embodiment, as shown in FIG. 4, the second hinge 8 is provided with mounting holes 81, which penetrate the second hinge 8 and the outer shell of the folding light panel 2, allowing the flexible conductive elements 3 to enter the interior of the folding light panel 2 to connect with the lighting units. Specifically, the mounting hole 81 refers to a through-hole that penetrates the second hinge 8 and the outer shell of the folding light panel 2. The second hinge 8 is located in the smallest area during the rotation of the folding light panel 2. By setting the mounting hole 81 on the second hinge 8 and allowing the flexible conductive elements 3 to enter the interior of the folding light panel 2 through the mounting hole 81, it can, to some extent, prevent the flexible conductive elements 3 from being pulled during the rotation of the folding light panels 2, thereby avoiding damage to the flexible conductive elements 3 and making the use of the lamp safer.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A lighting apparatus, comprising:
a driver module, wherein the driver module comprises a driver circuit and a driver housing, wherein the driver circuit converts an external power source to multiple driving currents;
multiple light source modules, wherein each light source module has a light source and a light housing, wherein the light housing encloses the light source and provides a light opening for a light of the light source to pass through; and
an unified fastener, wherein each light source has a power wire, wherein the power wires of the light sources have multiple wire ends coupled to the unified fastener to receive the driving currents of the driver circuit.

2. The lighting apparatus of claim 1, wherein the multiple driving currents are transmitted from the driver circuit via multiple power cables.

3. The lighting apparatus of claim 2, wherein the multiple power wires are respectively fixed to the power cables with multiple power connectors, wherein the power wires are fixed to the unified fastener.

4. The lighting apparatus of claim 1, wherein the unified fastener is a strain relief for absorbing and distributing tension placed on the power wires to prevent the power wires from being pulled out at their connection points.

5. The lighting apparatus of claim 1, wherein the light housing is protruding from a connection position of the driver housing to extend outwardly.

6. The lighting apparatus of claim 5, wherein the multiple light housings form a geometry extension shape.

7. The lighting apparatus of claim 5, wherein the light housing is a light wing that has the light opening facing to an illumination area.

8. The lighting apparatus of claim 7, wherein the light wings are foldable with respect to the driver housing to change their illumination areas.

9. The lighting apparatus of claim 7, wherein each light wing is detachable from the driver housing so that a number of the light wings are selectively coupled to the driver housing.

10. The lighting apparatus of claim 9, wherein a sensor is selectively attached to the light wing.

11. The lighting apparatus of claim 10, wherein the sensor comprises a motion sensor for detection of a human motion for the driver circuit to determine whether to turn on the light source.

12. The lighting apparatus of claim 9, wherein the driver circuit detects installed light wings to determine and adjust control of the light sources in the light wings.

13. The lighting apparatus of claim 1, wherein the unified fastener is a plastic structure for fixing the wire ends of the power wires of the multiple light sources and for fixing a cable end of the power cable.

14. The lighting apparatus of claim 13, wherein the driver housing has a cover, wherein the unified fastener has a fixing connector for fixing the unified fastener to the cover after the wire ends are fixed to the unified fastener.

15. The lighting apparatus of claim 1, wherein in a first working mode, at least a portion of the light sources are disabled while turning on other portion of the light sources at a period of time.

16. The lighting apparatus of claim 1, wherein each light housing has an Edison cap to attach to a corresponding Edison socket of the driver housing.

17. The lighting apparatus of claim 16, wherein the driver circuit determines an independent driving current to each light source.

18. The lighting apparatus of claim 1, further comprising a manual switch disposed on a surface of the driver housing for control a setting of the driver circuit.

19. The lighting apparatus of claim 18, wherein the manual switch has multiple sub-switches each corresponding to one light source to change the setting of the corresponding light source.

20. The lighting apparatus of claim 19, wherein the multiple light sources have different optical parameters.
